(19) United States
(12) Patent Application Publication
(10) Pub. No.: US 2011/0315465 A1
(43) Pub. Date: Dec. 29, 2011

(54) Universal Snow Blower Sled

(76) Inventor: Gary Michael Henry, Marlton, NJ (US)

(21) Appl. No.: 13/164,724

(22) Filed: Jun. 20, 2011

Related U.S. Application Data
(60) Provisional application No. 61/358,421, filed on Jun. 25, 2010.

(51) Int. Cl. E01H 5/09; B62M 27/02

(52) U.S. Cl. 180/182

(57) ABSTRACT

A universal snow blower sled system comprising two skid devices and attacheres such that the skid device(s) are removably attachable to the bottom of a snow blower machine rotary auger housing so that the auger is prevented from contacting a hard ground surface. The skid device(s) may have least one hole wherein the attacher is removably insertable through the hole(s) in the skid device and through the auger housing of the snow blower machine such that the skid device(s) is/are removably attached to the snow blower machine. The skid device(s) is/are attachably mounted to the housing such that the length of the skid device(s) runs parallel with the drive-wheel system of the snow blower machine and has an upturned front surface. The up-turned front surface allows the snow blower machine to ride on top of a hard packed snow or the ground surface and act as a ski device preventing damage to the rotary auger.

### CROSS-REFERENCE TO RELATED APPLICATION

The present application is related to and claims priority from prior provisional application Ser. No. 61/358,421, filed Jun. 25, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of snow blowers and more specifically relates to a snow blower sled accessory.

### 2. Description of the Related Art

During the winter months, many people in modern societies can be found outside of their home, office, or apartment, laboriously using a shovel to remove snow from their driveways and walkways. The local government may send a truck to plow the streets and apply salt to icy areas, but this does not solve the problem of clearing snow from one's front door to the shoveled streets or sidewalks. The task of removing accumulated snow from driveways, walkways, and sidewalks historically have required hard manual labor by way of using a snow shovel to scoop, lift, and heave the snow to the sides. In addition to shoveling snow, retail businesses may be faced with the added task of shoveling sand or snow on storefront sidewalks to afford traction for pedestrians and consumers, safeguarding them against injury due to slipping.

These types of shoveling tasks are physically demanding and may even be dangerous to individuals who are elderly or who are not physically fit. To avoid the hassles of a shovel, many individuals purchase and employ snow blowers. A snow blower is a machine for removing snow off the ground and is typically used to clear snow from driveways, sidewalks, roadways, paths, runways, railroad tracks, and the like. Snow blowers may operate on either electric power or a gasoline or diesel engine to throw snow to another location. Snow blowers are a useful electric or gas operated power tool in assisting land owners and occupiers in clearing snow off their property quickly and efficiently while expending less energy than using a conventional snow shovel. Furthermore, an individual who wishes to clear snow off their land has less risk injuring their backs, knees, and wrists while using a snow blower as opposed to a shovel. However, as convenient as snow blowers may be, individuals may encounter difficulties when a snow blower is used on unpaved or graveled surfaces, whereby the low-lying blower tends to “dig” into the ground surface, resulting in marred driveways and paths as well as picking up gravel which may damage the snow blower blades.

Various attempts have been made to solve the above-mentioned problems such as those found in U.S. Pat. Nos. 4,441,266; 6,508,018; and 2004/0205985. This prior art is representative of snow blower elevating accessories. None of the above inventions and patents, taken either singly or in combination, is seen to describe the invention as claimed.

Ideally, a snow blower sled system should be convenient in use and, yet, would operate reliably and be manufactured at a modest expense. Thus, a need exists for a reliable universal snow blower sled system to attach universally to walk behind snow blower machines and to avoid the above-mentioned problems.

### BRIEF SUMMARY OF THE INVENTION

In view of the foregoing disadvantages inherent in the known snow blower, the present invention provides a novel universal snow blower sled system. The general purpose of the present invention, which will be described subsequently in greater detail is to provide greater convenience of use and protection of the snow blower machine.

Disclosed herein is a universal snow blower sled system with at least one but preferably two skid devices held thereto by at least one attacher which may be bolt fasteners, but in some embodiments, could be a shaft with through-hole wherein a ring-pin may be inserted through the shaft and biasly coupled. The skid device(s) preferably removably attach to a bottom portion of a snow blower machine such that a rotary auger within the snow blower machine is substantially prevented from contacting a hard planar surface thereby preventing damage to the rotary auger which displaces snow located on the hard planar surface (the ground, driveway or the like.) This is accomplished by the skid devices maintaining a clearance-distance of at least the thickness of the skid device (shims may also be used). The skid device(s) further comprise at least one hole wherein the attacher is removably insertable through the hole(s) in the skid device and through hole(s) in the housing of the snow blower machine such that the skid device(s) is/are removably attached to the snow blower machine.

The skid device is attachably mounted to the housing such that the length of the skid device(s) runs parallel and adjacent to an outer edge of the housing. The skid device(s) run parallel with the drive-wheel system of the snow blower machine and have a length greater than the width, having a perpendicularly-oriented outside planar edge-wall, and an upturned front surface (ski-profile). The skid plate may have a back surface with no end-wall such that snow is not collected on the skid plate when the snow blower machine is in motion. The up-turned front surface allows the snow blower machine to ride on top of a hard packed snow or the ground surface and act as a ski device. The skid device may comprise aluminum, a ferrous material, or a composite material resistant to brittle fracture.

A method of use for a universal snow blower sled system may comprise the steps of: positioning at least one skid device adjacent to the snow blower machine; (removably) attaching the at least one skid device to snow blower machine using at least one suitable attacher; using the snow blower machine with the universal snow blower sled system attached for removing snow and optionally, removing snow blower sled system, if desired by the user, and storing the snow blower machine and snow blower sled system for a future use (separately or together—installed.)

The universal snow blower sled system may be manufactured as a kit including at least one skid device; at least one attacher; and a set of user-instructions for installation and use of the universal snow blower sled system.

The present invention holds significant improvements and serves as a universal snow blower sled system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, universal snow blower sled system, constructed and operative according to the teachings of the present invention.

FIG. 1 shows a perspective view illustrating universal snow blower sled systems according to an embodiment of the present invention.

FIG. 2 is a perspective view illustrating universal snow blower sled systems installed on a snow blower machine according to an embodiment of the present invention of FIG. 1.

FIG. 3 is a perspective view illustrating an inner side view angle of the device according to an embodiment of the present invention of FIG. 1.

FIG. 4 is a perspective view illustrating an outer side view angle of the device according to an embodiment of the present invention of FIG. 1.

FIG. 5 is a flowchart illustrating a method of using the universal snow blower sled systems according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a snow blower skid device and more particularly to universal snow blower sled system 100 as used to improve the protection of the snow blower machine 110 while reducing maintenance and repair costs and adding convenience for its user(s).

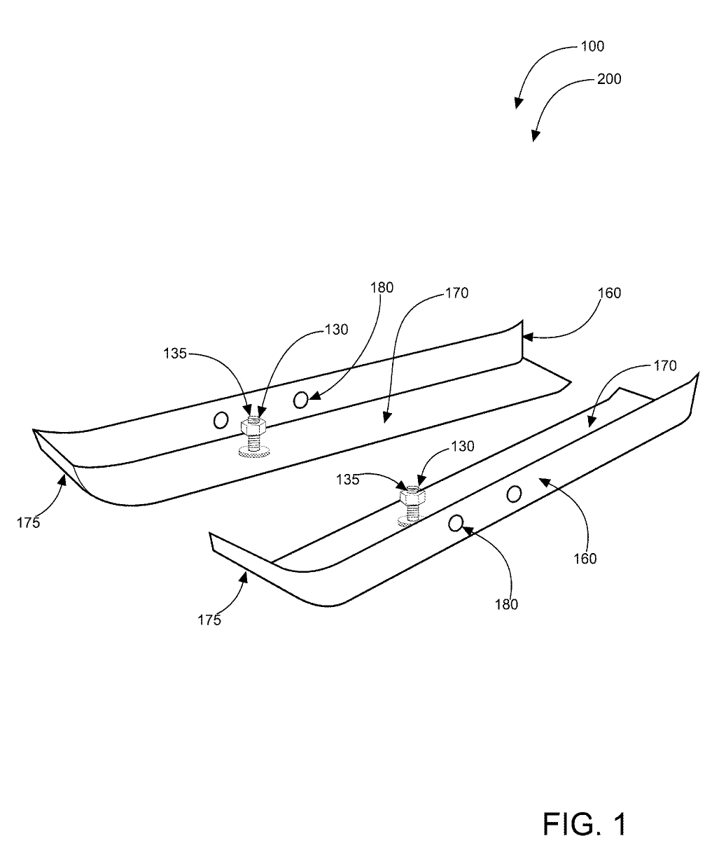

Referring to the drawings by numerals of reference there is shown in FIG. 1, a perspective view illustrating universal snow blower sled system 100 installed on snow blower machine 110 according to an embodiment of the present invention.

The primary object of universal snow blower sled system 100 recognizes a need for a sled system that may be mounted to a conventional snow blower machine 110 to provide an elevated snow surface attack for snow blower machine 110 while in use. Universal snow blower sled system 100 may preferably comprise a pair of skids 120 with screws and bolt fasteners 135 such that skids 120 may be mounted to the bottom of each side of a snow blower auger housing. Universal snow blower sled system 100 may comprise at least one skid(s) 120 device and at least one attacher 130 used to removably attach skid(s) 120 to a bottom portion of snow blower machine 110 such that rotary auger 112 within snow blower machine 110 is effectively prevented from contacting hard planar surface 140.

At least one but preferably two attacher(s) 130 are used to removably attach at least two skid(s) 120 to bottom portion of snow blower machine 110 such that rotary auger 112 is able to rotate and displace snow located on hard planar surface 140 while maintaining a suitable clearance-distance of rotary auger 112 from hard planar surface 140. In this way the present invention serves to prevent rotary auger 112 from contacting loose debris (pebbles, sharp concrete edges, etc.) often found on the ground, cement pad, sidewalk or other.

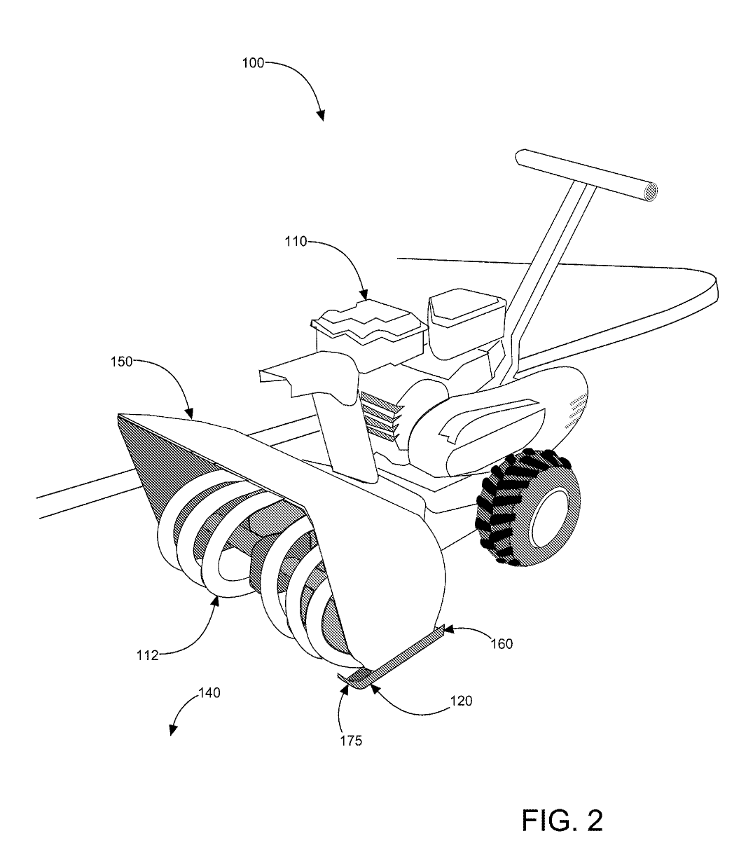

Referring now to FIG. 2, a perspective view illustrating universal snow blower sled system 100 installed on snow blower machine 110 according to an embodiment of the present invention of FIG. 1. Skid(s) 120 is/are preferably attachably mounted (suitably affixed) to housing 150 such that length of Skid(s) 120 run parallel and adjacent to an outer edge of housing 150 and run parallel with a drive-wheel system of snow blower machine 110. Skid(s) 120 elevate snow blower machine 110 so that damage is suitably prevented to rotary auger 112 by contacting gravel or hard rock surface(s).

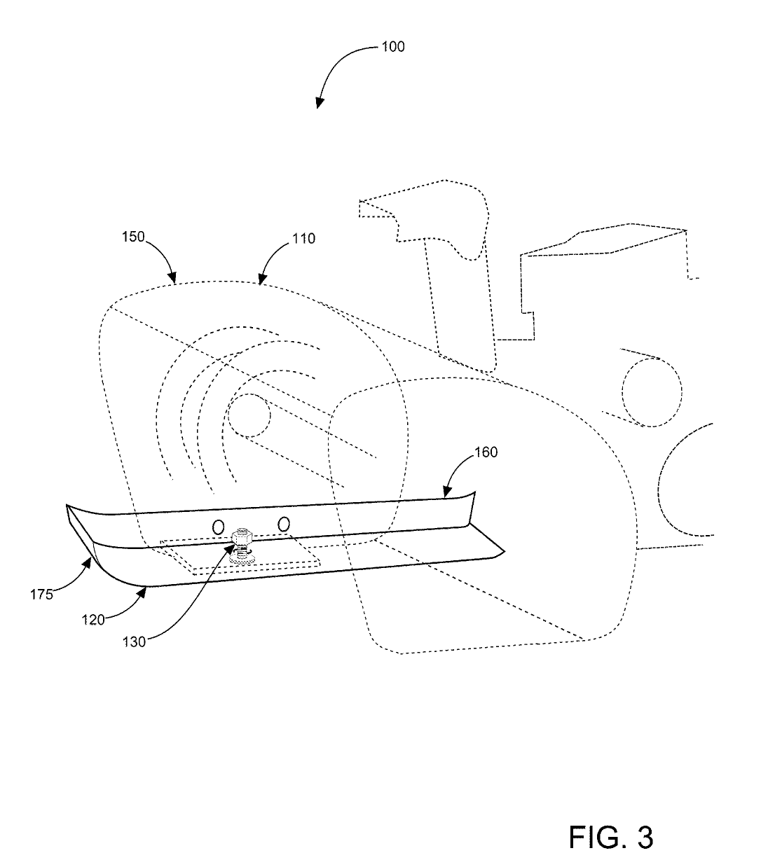

Referring now to FIG. 3, a perspective view illustrating an inner side view angle of the device according to an embodiment of the present invention of FIG. 1.

Universal snow blower sled system 100 comprises at least one skid(s) 120 having a length and a width such that the length is greater than the width and may further have two skid(s) 120 of equal size that may preferably resemble the shape of runners on a sled or that of skis (ski-profile) measuring approximately 10″ in length, 2″ in height, and 3″ in width. Skid(s) 120 functions as a ski to displace obstacles when moving in a forward direction and further may comprise perpendicularly-oriented outside planar edge-wall 160 to provide structural support for skid(s) 120 in some embodiments. Typically skid(s) 120 are constructed of a metal or other suitably durable material. Skid(s) 120 (acting as a skid-plate) may comprise an upturned front surface and a back surface with no end-wall such that snow is not collected on upper surface of skid plate 170 to minimize corrosion. The upturned front surface 175 allows snow blower machine 110 to ride on top of snow located on hard planar surface 140.

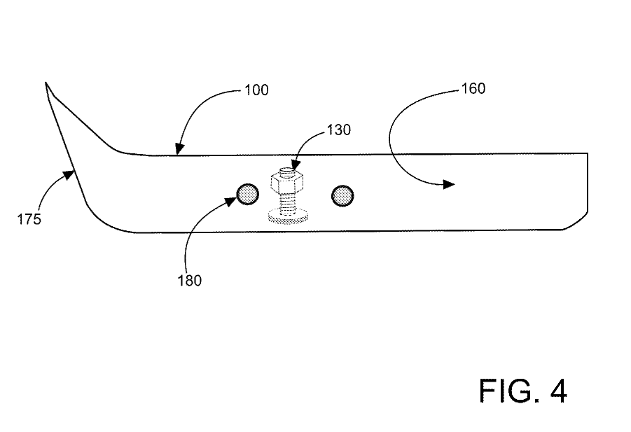

Referring now to FIG. 4, a perspective view illustrating an outer side view angle of the device according to an embodiment of the present invention of FIG. 1. Skid(s) 120 may further have at least one hole(s) 180 wherein attacher(s) 130 is removably insertable through hole(s) 180 in at least one skid device and through hole(s) in a housing of snow blower machine 110 such that at least one skid(s) 120 is removably attached to snow blower machine 110. Attacher(s) 130 are located so as to be attachable to the bottom and sides of the housing and are located horizontally rather than vertically to provide height adjustment along the length of the housing (such that skid(s) 120 may be inclined from front to back or vice-versa—according to attacher 130 placement). Further, wheels are not used in the present design. Attachers 130 may be orientated horizontally along the housing of snow blower machine 110 and may be located underneath as well for greater structural stability. Attacher(s) 130 may comprise bolt fasteners 135 but in some embodiments may be a shaft with through-hole wherein a ring-pin may be inserted through shaft and biasly coupled thereby. Other suitable screws and bolt fasteners 135 may be used to mount and secure each skid(s) 120 to snow blower machine 110 skid pad located on the underside of the snow blower machine 110. In this manner, snow blower machine 110 may be raised approximately 2″ higher and provide a slight elevation means for snow blower machine 110 while in use which may facilitate a smoother operation of snow blower machine 110. The thickness of skid(s) 120 (skid-plate) comprises a clearance between rotary auger 112 and hard planar surface 140 allowing for a minimum suitable distance between rotary auger 112 and hard planar surface 140. Skid(s) 120 may be constructed of aluminum or a ferrous material, or skid(s) 120 may be constructed of a composite material resistant to brittle fracture.

Universal snow blower sled systems 100 may be sold as kit 200 comprising the following parts: at least one attacher(s) 130; at least one skid(s) 120; and a set of user-instructions for installation and use. Universal snow blower sled systems 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

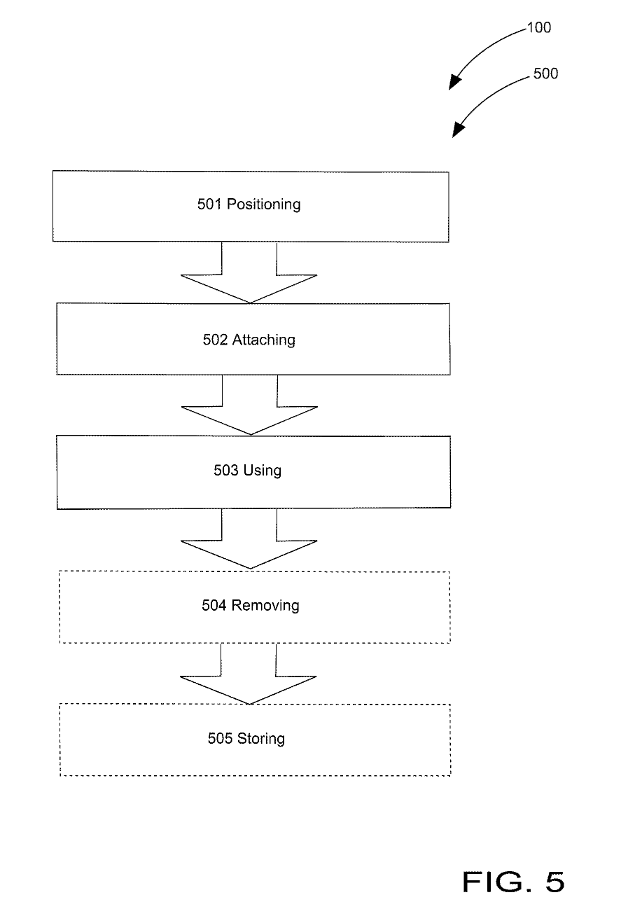

Referring now to FIG. 5, is a flowchart illustrating method of use 500 for universal snow blower sled system 100 according to an embodiment of the present invention of FIG. 1.

Method of use for universal snow blower sled systems 100 may comprise the steps of: step one 501 positioning at least one skid(s) 120 to snow blower machine 110; step two 502 attaching at least one skid(s) 120 to snow blower machine 110 using at least one attacher(s) 130; and step three 503 using snow blower machine 110 with universal snow blower sled system 100 attached to displace snow as desired. Method of use 190 for universal snow blower sled system 100 may further comprise the steps of step four 504 removing universal snow blower sled system 100 from snow blower machine 110 if desired by a user; and step five 505 storing snow blower machine 110 and universal snow blower sled system(s) 100. Further, skid(s) 120 may be optionally inclined as desired along the horizontal side of the housing to direct snow blowing angle relative to the ground surface.

It should be noted that step 504 and 505 are optional steps and may not be implemented in all cases. Optional steps of method 500 are illustrated using dotted lines in FIG. 5 so as to distinguish them from the other steps of method 500.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A universal snow blower sled system comprising:
at least one skid device; and
at least one attacher;
wherein said skid device removably attaches to a bottom portion of a snow blower machine such that a rotary auger within said snow blower machine is prevented from contacting a hard planar surface;
wherein said at least one skid device does not comprise wheels;
wherein said skid(s) may be inclined from front to back according to placement of said attacher(s); and
wherein said at least one attacher is used to removably attach said at least one skid device to said bottom portion of said snow blower machine such that said rotary auger is able to rotate and displace snow located on said hard planar surface while maintaining a clearance-distance of said rotary auger from said hard planar surface.

2. The universal snow blower sled system of claim 1 wherein said at least one skid device has a length and a width such that said length is greater than said width.

3. The universal snow blower sled system of claim 1 wherein said at least one skid device comprises a ski.

4. The universal snow blower sled system of claim 3 wherein said at least one skid device further comprises a perpendicularly-oriented outside planar edge-wall.

5. The universal snow blower sled system of claim 1 wherein said at least one skid device further comprises at least one hole and wherein said attacher is removably insertable through said hole(s) in said at least one skid device and through hole(s) in a housing of said snow blower machine such that said at least one skid device is removably attachable to said snow blower machine.

6. The universal snow blower sled system of claim 2 wherein said skid device is attachably mounted to said housing such that said length of said skid device(s) run parallel and adjacent to an outer edge of said housing, said attachers orientated horizontally along said housing of said snow blower machine.

7. The universal snow blower sled system of claim 6 wherein said skid device(s) run parallel with a drive-wheel system of said snow blower machine.

8. The universal snow blower sled system of claim 3 wherein said skid plate comprises an upturned front surface.

9. The universal snow blower sled system of claim 3 wherein said skid plate comprises a back surface with no end-wall such that said snow is not collected on said skid plate.

10. The universal snow blower sled system of claim 8 wherein said upturned front surface allows said snow blower machine to ride on top of said snow located on said planar surface.

11. The universal snow blower sled system of claim 3 wherein a thickness of said skid plate comprises a clearance distance between said rotary auger and said planar surface.

12. The universal snow blower sled system of claim 1 wherein said skid device comprises aluminum.

13. The universal snow blower sled system of claim 1 wherein said skid device comprises a composite material resistant to brittle fracture.

14. The universal snow blower sled system of claim 1 wherein said at least one attacher comprises bolt fasteners.

15. The universal snow blower sled system of claim 1 wherein said at least one attacher comprises a shaft with a through-hole wherein a ring-pin may be inserted through said shaft and biasly coupled thereby.

16. The universal snow blower sled system of claim 3 wherein said skid device(s) comprise ferrous material.

17. A universal snow blower sled system comprising:
at least one skid device;
at least one attacher;
wherein said skid device removably attaches to a bottom portion of a snow blower machine such that a rotary auger within said snow blower machine is prevented from contacting a hard planar surface;
wherein said at least one attacher is used to removably attach said at least one skid device to said bottom portion of said snow blower machine such that said rotary auger is able to rotate and displace snow located on said hard planar surface while maintaining a clearance-distance of said rotary auger from said hard planar surface;
wherein said at least one attacher comprises bolt fasteners or a shaft with a through-hole wherein a ring-pin may be inserted through said shaft and biasly coupled thereby;
wherein said at least one skid device further comprises at least one hole and wherein said attacher is removably insertable through said hole(s) in said at least one skid device and through hole(s) in a housing of said snow blower machine such that said at least one skid device is removably attached to said snow blower machine;
wherein said skid device is attachably mounted to said housing such that said length of said skid device(s) run parallel and adjacent to an outer edge of said housing;
wherein said skid device(s) run parallel with a drive-wheel system of said snow blower machine;
wherein said at least one skid device has a length and a width such that said length is greater than said width;
wherein said skid plate comprises an upturned front surface;
wherein said skid plate comprises a back surface with no end-wall such that said snow is not collected on said skid plate to avoid corrosion;
wherein said upturned front surface allows said snow blower machine to ride on top of said snow located on said planar surface;
wherein said at least one skid device comprises a ski;
wherein said skid device comprises aluminum or ferrous material or a composite material resistant to brittle fracture;
wherein a thickness of said skid plate comprises a clearance between said rotary auger and said planar surface; and
wherein said at least one skid device further comprises a perpendicularly-oriented outside planar edge-wall.

18. The universal snow blower sled systems of claim 17 further comprising a kit including said at least one skid device; said at least one attacher; and a set of user-instructions for installation and use.

19. A method of use for a universal snow blower sled system comprising the steps of:
positioning at least one skid device adjacent to a snow blower machine;
attaching said at least one skid device to said snow blower machine using at least one attacher; and
using said snow blower machine with said universal snow blower sled systems attached to displace snow.

20. The method of claim 19 further comprising the steps of:
removing said snow blower sled systems from said snow blower machine if desired by a user; and
storing said snow blower machine and said universal sled systems.
